(19) United States
(12) Patent Application Publication
(10) Pub. No.: US 2017/0303526 A1
(43) Pub. Date: Oct. 26, 2017

(54) PEST BARRIER SYSTEM FOR PLUMBING OF MOBILE VEHICLES

(71) Applicant: Charles Ronald Emanuel, Amarillo, TX (US)

(72) Inventor: Charles Ronald Emanuel, Amarillo, TX (US)

(21) Appl. No.: 15/593,201

(22) Filed: May 11, 2017

Related U.S. Application Data
(63) Continuation of application No. 14/746,292, filed on Jun. 22, 2015, now abandoned.
(60) Provisional application No. 62/021,794, filed on Jul. 8, 2014.

(51) Int. Cl. A01M 29/30; A01G 13/02; B60P 3/36; B60R 15/00; B60R 99/00

(52) U.S. Cl. CPC A01M 29/30; B60R 15/00; B60R 99/00; A01G 13/0237; B60P 3/36; B60R 2099/005

(57) ABSTRACT

A device useful as a pest barrier system for plumbing of mobile vehicles or plant barrier system is disclosed. The pest barrier system for plumbing of mobile vehicles comprising a pest protection system having a first half, a second half, a lower portions and an upper portions. The lower portions of the pest protection system comprise a lower rim. The upper portions of the pest protection system comprises an upper rim. The lower rim comprises a lower external diameter and a lower internal diameter. The upper rim comprises an upper external diameter. The pest protection system fits within a plumbing compartment of a mobile vehicle at a gap comprising an internal diameter which is smaller than the upper external diameter of the upper rim of the pest protection system. The lower portions of the pest protection system receives a portion of a fluid drainage hose having an external hose diameter.

### CROSS REFERENCE TO RELATED APPLICATION

This application claims the benefit of the earlier filing date of U.S. application Ser. No. 14/746,292, filed Jun. 22, 2015, and U.S. Provisional Application No. 62/021,794, filed Jul. 8, 2014. The entire disclosures of the prior applications are incorporated herein by reference.

### FIELD

Certain embodiments of the present invention concern embodiments of a device and method for its use, such as a pest barrier system for preventing pests from entering mobile vehicle plumbing systems, and to surround, or at least partially surround plants, such as trees, to protect the plant from damage.

### BACKGROUND

This disclosure relates generally to a pest barrier system for plumbing of mobile vehicles. None of the known inventions and patents, taken either singularly or in combination, is seen to describe the instant disclosure as claimed. Accordingly, an improved pest barrier system for plumbing of mobile vehicles would be advantageous.

The pest barrier system for plumbing of mobile vehicles can comprise a pest protection system to be used in the Recreational Vehicle (RV) Industry or mobile vehicles in general. More specifically the pest protection system can be used in class “A”, “B” and NCU type RV's which can have enclosed storage bays (also called a plumbing compartment) for plumbing hoses, valves and controls.

There can be a six inch diameter access hole in the floor of these bays to allow the three inch sewer hose to drop down and extend to the sewer drain. A three inch diameter sewer hose feeding through a six inch diameter access port hole leaves a 1.5 inch gap space all the way around the hose. The pest protection system can be designed to go around a standard three inch hose and fill the gap between the hose and the six inch access hole.

For decades RV owners have tried many ways to plug up this gap with paper, rags, towels and foam products etc., to keep mice and varmints (critters) from gaining access into the RV storage compartment. Once critters get into the plumbing storage bay, they can chew through grommets and find very small spaces to get into the interior of the motorhome. The pest protection system addresses this common problem.

The pest protection system is designed to snap around any standard three inch sewer hose. It can be scaled up or down to fit other size hoses if needed. The pest protection system is uniquely designed as a single part which can be mirrored with a second identical part to form a conical shape to snap together around a three inch sewer hose (for example).

The pest protection system's unique ingenious design of using a split two part design of matching identical parts, allows the RV user to stretch out the sewer hose through the plumbing bay access hole all the way to the RV park sewer drain. There is no need to thread the hose through a one piece cone shaped type device. After the hose is properly set up, it is very easy to snap the two parts of the pest protection system around the hose and slide it down into the six inch access hole. The conical shape will wedge itself tightly down around the hose thereby sealing the gap space between the hose and the access port hole.

The pest protection system is designed with a smooth interior so sewer hose will not get snagged causing pin-holes that may develop possible leaks.

The pest protection system can be manufactured using the latest CNC Plastic Injection Molding processes. Thermo-Plastic and Thermo-set type plastics may be the first choice of material. Using sheet metal made from aluminum or stainless steel could be used but would add to production cost. Also, a two part design held together with hinges and pinned snaps also can be used. Disclosed embodiments are effective, cost efficient, and a practical solution to a long standing problem of animals invading the RV living space by climbing up the sewer hose.

### SUMMARY

Several embodiments of a pest barrier system for mobile vehicle plumbing systems are disclosed. Certain disclosed embodiments of a pest barrier system for mobile vehicle plumbing systems comprise a pest protection system having a first half, a second half, a lower portion and an upper portion. The pest protection system further comprises an internal passage. Lower portions of the pest protection system comprise a lower rim, and the upper portions of the pest protection system comprise an upper rim. The lower rim comprises a lower external diameter and a lower internal diameter. The upper rim comprises an upper external diameter. The pest protection system fits within a plumbing compartment of a mobile vehicle at a gap of a compartment floor of the plumbing compartment. The internal diameter of the gap is smaller than the upper external diameter of the upper rim of the pest protection system. The lower portions of the pest protection system receives a portion of a fluid drainage hose having an external hose diameter. The lower internal diameter of the lower portions of the pest protection system is greater than or equal to the external hose diameter of the fluid drainage hose.

Disclosed embodiments also can be used to protect plants, such as tree trunks. For example, disclosed embodiments of the device can be inverted and positioned around a tree trunk, thereby preventing damage to the tree.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic perspective drawing of a recreational vehicle having one embodiment of the mobile vehicle plumbing system barrier system according to the present invention.

FIG. 2A is a perspective view of a plumbing compartment of a mobile vehicle without a pest protection system.

FIG. 2B is an enlarged plan view of a portion of the plumbing compartment without a pest protection system as illustrated in FIG. 2A.

FIG. 2C is a perspective view of a mobile vehicle plumbing compartment comprising one embodiment of a pest protection system according to the present invention.

FIG. 3A is a perspective front view of one embodiment of a device according to the present invention in a detached configuration.

FIG. 3B is a perspective rear view of one embodiment of a device according to the present invention in a detached configuration.

FIGS. 3C, 3D, 3E, 3F, 3G and 3H illustrate a lip and tooth portion of an embodiment of a latching system according to one embodiment of the present invention.

FIG. 4A is a perspective outside view of one embodiment of a device according to the present invention.

FIG. 4B is a perspective inside view of one embodiment of a device according to the present invention.

FIG. 4C is an elevated front view of one embodiment of a portion of a device according to the present invention.

FIG. 4D is an elevated side view of one embodiment of a portion of a device according to the present invention.

FIG. 5A is a perspective view of one embodiment of a device according to the present invention.

FIG. 5B is an elevated view of one embodiment of a device according to the present invention.

FIG. 5C is a side view of one embodiment of a portion of a device according to the present invention.

FIG. 5D is an elevated view of one embodiment of a portion of a device according to the present invention.

FIG. 5E is a side view of one embodiment of a portion of a device according to the present invention.

FIG. 6A is a perspective view illustrate the plumbing compartment 102 without the pest protection 200 installed.

FIG. 6B is an elevated view illustrating the plumbing compartment 102 without the pest protection 200 installed.

FIG. 6C is a perspective view illustrating one embodiment of the pest protection system installed into a plumbing compartment.

FIG. 6D is a cross sectional view illustrating one embodiment of the pest protection system installed into a plumbing compartment.

### DETAILED DESCRIPTION

Described herein is a pest barrier system for plumbing of mobile vehicles. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

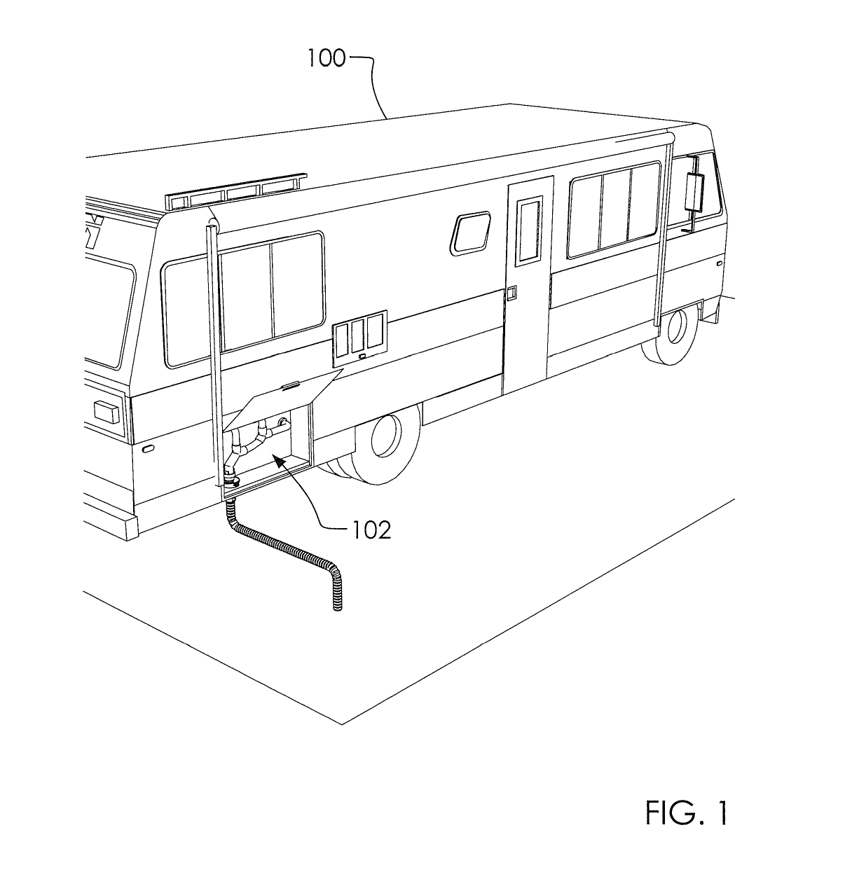

FIG. 1 illustrates a perspective overview of a mobile vehicle 100 having a plumbing compartment 102.

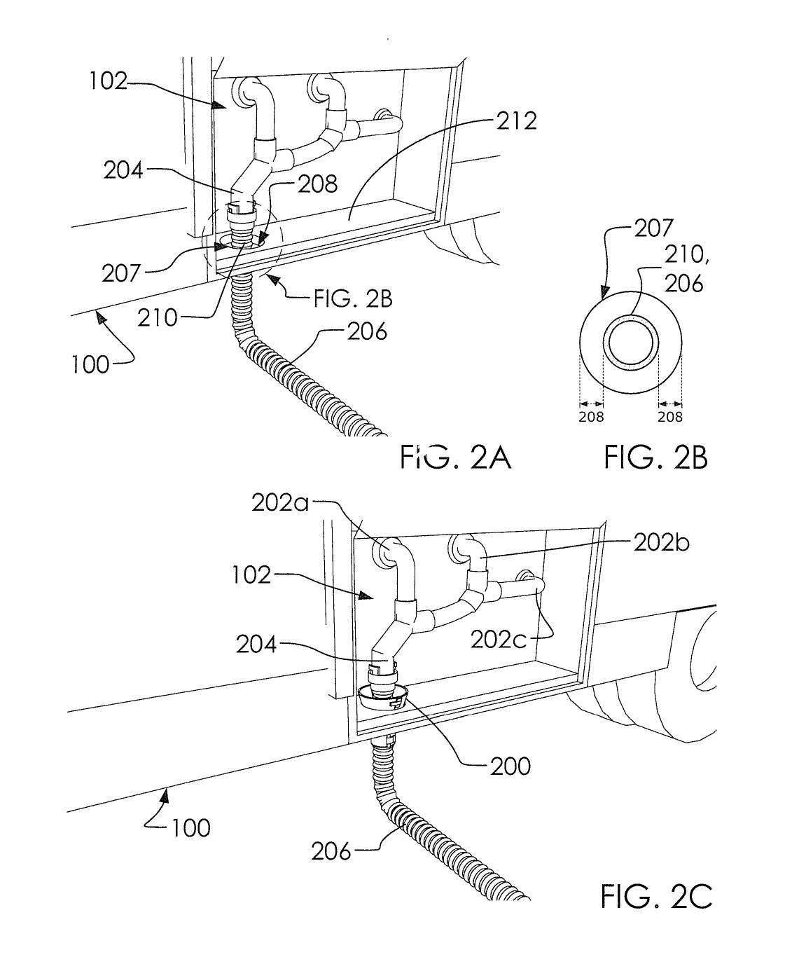

FIGS. 2A, 2B and 2C illustrate a perspective overview of the plumbing compartment 102 without a pest protection system 200, an elevated top view of an aperture 207 in the plumbing compartment 102 with a cross-section view of a fluid drainage hose 206, and a perspective overview of the plumbing compartment 102 with the pest protection system 200, respectively. In one embodiment, the mobile vehicle 100 can comprise one or more fluid outputs, which can comprise a first output 202a, a second output 202b and a third output 202c. In one embodiment, the one or more fluid outputs can attach to an outlet nozzle 204, as is known in the art. In one embodiment, the outlet nozzle 204 can attach to the fluid drainage hose 206 through the aperture 207. In one embodiment, a gap 208 can exist between a first end 210 of the drainage hose 206 and the aperture 207. In one embodiment, the first end 210 can attach to the outlet nozzle 204, as is known in the art. In one embodiment, the one or more pests can access the plumbing compartment 102, and other interior portions of the mobile vehicle 100, through the gap 208 and/or the aperture 207. In one embodiment, the plumbing compartment 102 can comprise a compartment floor 212.

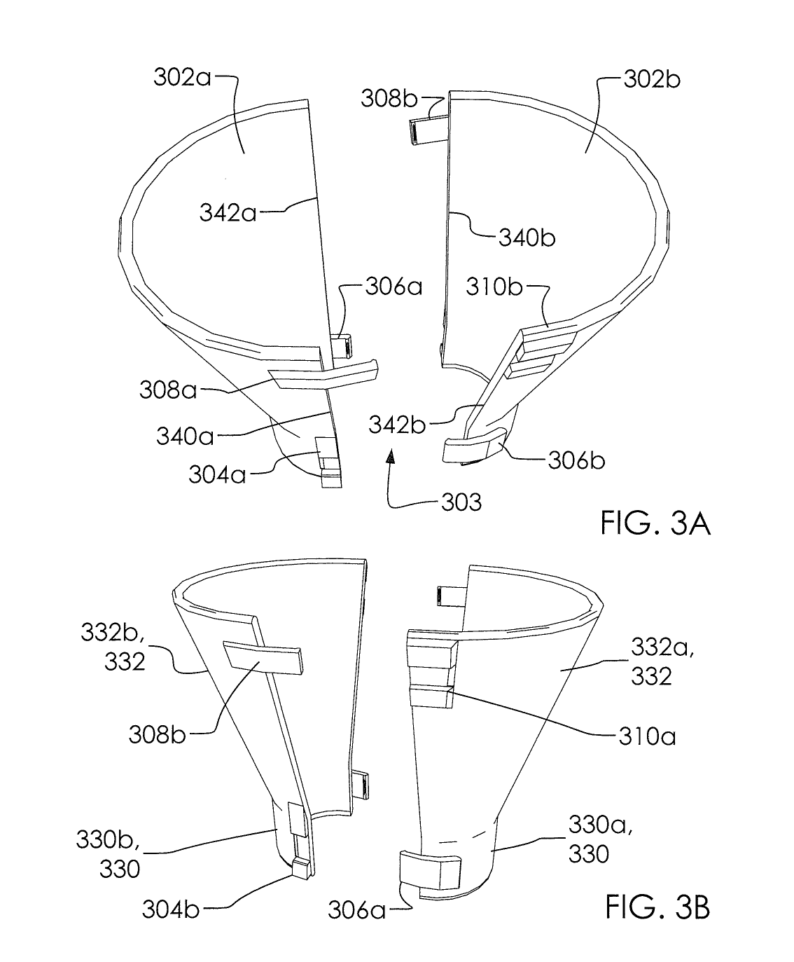

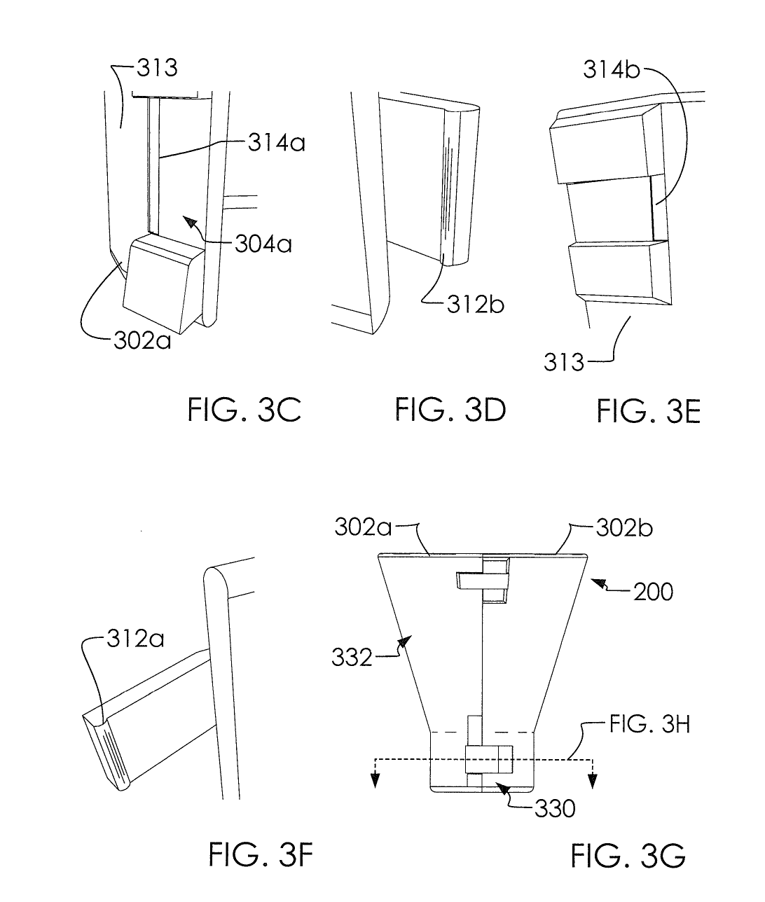

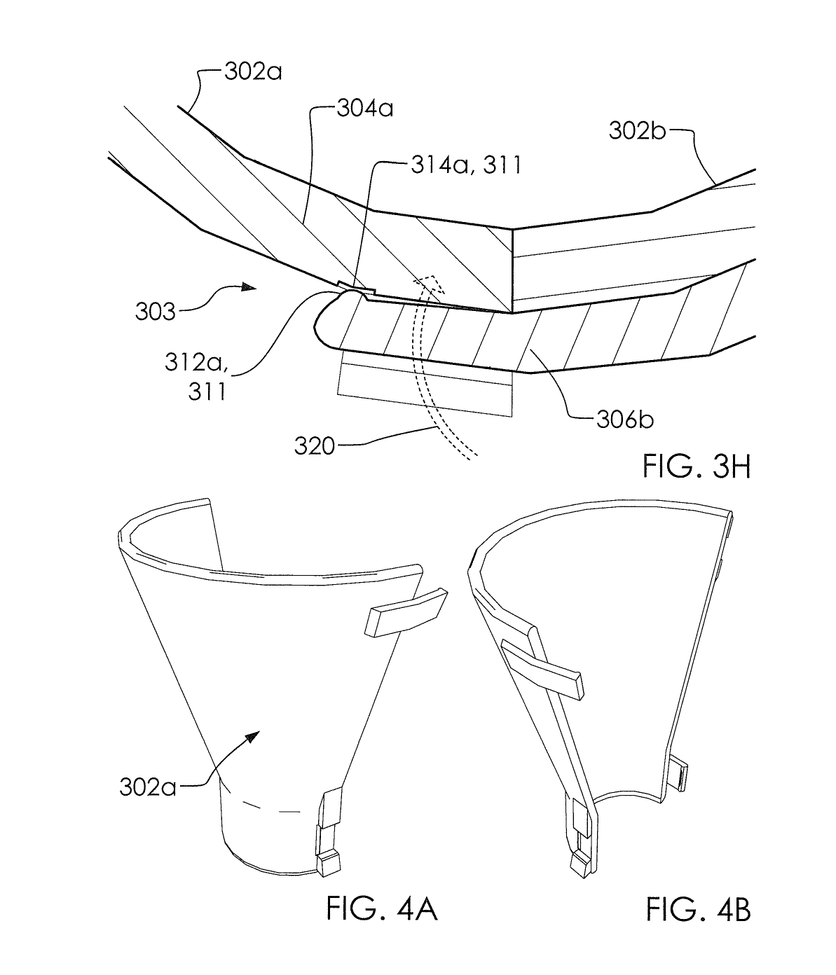

FIGS. 3A and 3B illustrate a perspective front and rear overview of the pest protection system 200, having a first half 302a and a second half 302b, in a detached configuration. In one 10 embodiment, the pest protection system 200 can comprise a latching system 303. In one embodiment, the latching system 303 can be partially on the first half 302a and partially on the second half 302b. In one embodiment, the latching system 303 can comprise of a first lower receiving portion 304a, a second lower receiving portion 304b, a first lower latching portion 306a, a second lower latching portion 306b, a first upper latching portion 308a, a second upper latching portion 308b, a first upper receiving portion 310a, and a second upper receiving portion 310b. Thus, in one embodiment the pest protection system 200 can comprise the first half 302a and the second half 302b capable of attaching to one another with the latching system 303. In one embodiment, the latching system 303 can be the to have a one or more receiving portions (which can comprise the first lower receiving portion 304a, the second lower receiving portion 304b, the second lower receiving portion 304b and the first upper receiving portion 310a) and a one or more latching portions (which can comprise the first lower latching portion 306a, the second lower latching portion 306b, the first upper latching portion 308a and the second upper latching portion 308b).

FIGS. 3C, 3D, 3E, 3F, 3G and 3H illustrate a lip and tooth portion 311 of the latching system 303. FIG. 3C illustrates a perspective overview of a lower lip 314b of the first lower receiving portion 304a. FIG. 3D illustrates a perspective overview of a lower tooth 312a of the first lower receiving portion 304a. FIG. 3E illustrates a perspective overview of an upper lip 314b of the first upper receiving portion 304a. FIG. 3F illustrates a perspective overview of an upper tooth 312a of the first upper receiving portion 304a. In one embodiment, the first lower receiving portion 304a contains a lower lip 314b and the first lower latching portion 306a contains a lower tooth 312a. In one embodiment, the lower tooth 312a fits snugly into the lower lip 314b to ensure the latching system 303 does not involuntarily separate. In one embodiment, the tension force 320 can press the one or more latching portions against the one or more receiving portions to hold the first half 302a and the second half 302b together. Likewise, in one embodiment, the upper tooth 312a can fit snuggly into the upper lip 314b. In one embodiment, the lower lip 314b and the upper lip 314b can comprise a depression in a portion of an outer sidewall 313 of the pest protection system 200 capable of receiving a portion of the lower tooth 312a and/or the upper tooth 312a, respectively. In one embodiment, with the pest protection system 200 in the assembled configuration, a portion of the lower tooth 312b can be inserted into the lower lip 314a, and a portion of the lower tooth 312b can be inserted into the upper lip 314b. Thus, in one embodiment it can be the that the lip and tooth portion 311 can comprise a one or more lips (comprising the lower lip 314a and the upper lip 314b) and a one or more teeth (comprising the lower tooth 312b and the lower tooth 312b); wherein the one or more teeth attach to the one or more lips when the pest protection system 200 is in the attached configuration. In one embodiment, the pest protection system 200 can comprise one or more lip and tooth portions (such as the lip and tooth portion 311).

FIG. 3G illustrates an elevated front view of the pest protection system 200 in an assembled configuration with a cross-section indictor for FIG. 3H. In one embodiment, the pest protection system 200 can comprise a lower portion 330 (comprising a first lower portion 330a and a second lower portion 330b) and an upper portion 332 (comprising a first upper portion 332a and a second upper portion 332b). As illustrated in FIG. 3G, with the pest protection system 200 in the assembled configuration, the upper portions 332 can substantially comprise a conical shape and the lower portions 330 can substantially comprise a cylindrical shape.

In one embodiment, the first half 302a can comprise a first vertical edge 340a and a second vertical edge 342a, and the second half 302b can comprise a first vertical edge 340b and a second vertical edge 342b. In one embodiment, attaching the first half 302a to the second half 302b can comprise: aligning and pressing the first vertical edge 340a with the second vertical edge 342b, and aligning and pressing the second vertical edge 342a with the first vertical edge 340b (as illustrated in FIG. 3A), and holding the first half 302a together with the second half 302b with the latching system 303.

FIG. 3H illustrates an elevated cross-section top side view of the latching system 303. In one embodiment, attaching the one or more receiving portions to the one or more latching portions can comprise sliding the one or more latching portions through the one or more receiving portions and holding the one or more latching portions within the one or more receiving portions with a tension force 320 (illustrated in FIG. 3H). In one embodiment, the lower lip 314a can comprise a trough in the pest protection system 200 for receiving the upper tooth 312a.

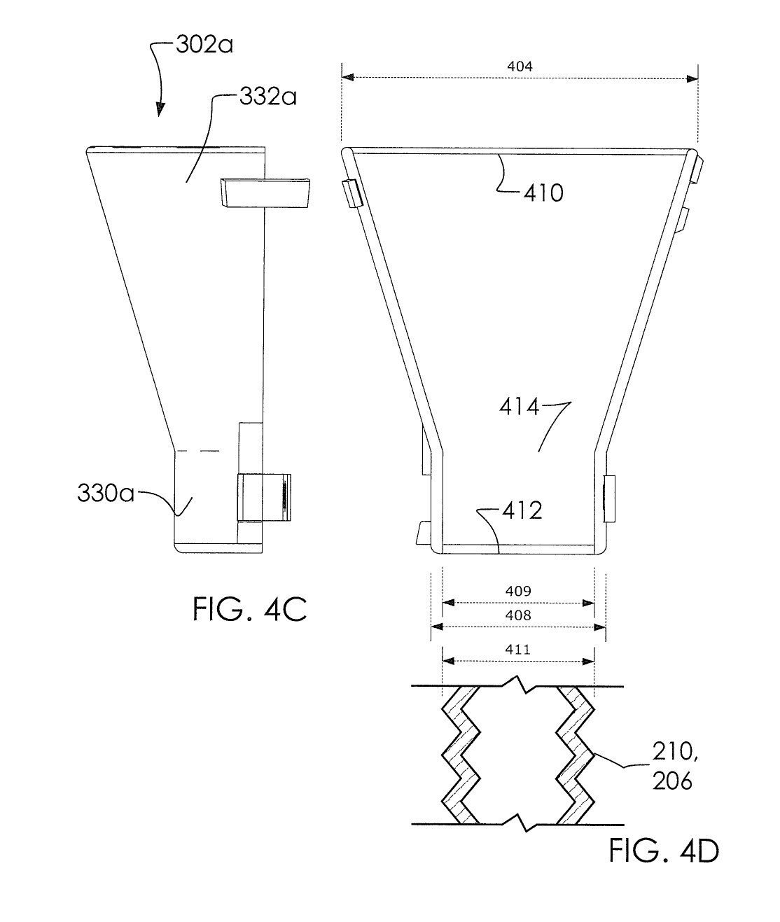

FIGS. 4A, 4B, 4C and 4D illustrate the first half 302a. FIGS. 4A and 4B illustrate a perspective outside and inside overview of the first half 302a. FIGS. 4C and 4D illustrate an elevated front and side view of the first half 302a. FIG. 4D further illustrates a cross-section elevated front view of the fluid drainage hose 206. In one embodiment, the first half 302a and the second half 302b can be substantially identical; wherein the latching system 303 are adapted to attach the first half 302a and the second half 302b together, as discussed above.

As viewed from the side view of FIG. 4D, the first half 302a can comprise an upper external diameter 404, and a lower portion 406 having a lower external diameter 408 and a lower internal diameter 409. In one embodiment, the pest protection system 200 can comprise a substantially symmetrical object; accordingly, when the first half 302a and the 302b are in the assembled configuration, the upper external diameter 404 can comprise a diameter of the upper portions 332 and the lower external diameter 408 and the lower internal diameter 409 can, likewise, be associated with the lower portions 330. In one embodiment, the upper external diameter 404 can comprise a maximum diameter for the pest protection system 200, and the lower external diameter 408 can comprise a minimum diameter for the pest protection system 200. In one embodiment, the first half 302a can comprise an upper rim 410, a lower rim 412 and a joining point 414. In one embodiment, the first lower portion 330a can meet the first upper portion 332a at the joining point 414. In one embodiment, where the lower portions 330 is conical, the lower external diameter 408 and the lower internal diameter 409 can remain substantially unchanged between the lower rim 412 and the joining point 414. In one embodiment, the first end 210 of the drainage hose 206 can comprise an external hose diameter 411; wherein, the lower internal diameter 409 can be equal to or greater than the external hose diameter 411. Thus, in one embodiment the first end 210 of the fluid drainage hose 206 can be held within the lower portions 330 of the pest protection system 200. Further, where the lower internal diameter 409 is substantially equal to the external hose diameter 411, the pest protection system 200 can create a tight barrier around the fluid drainage hose 206 at the lower portions 330.

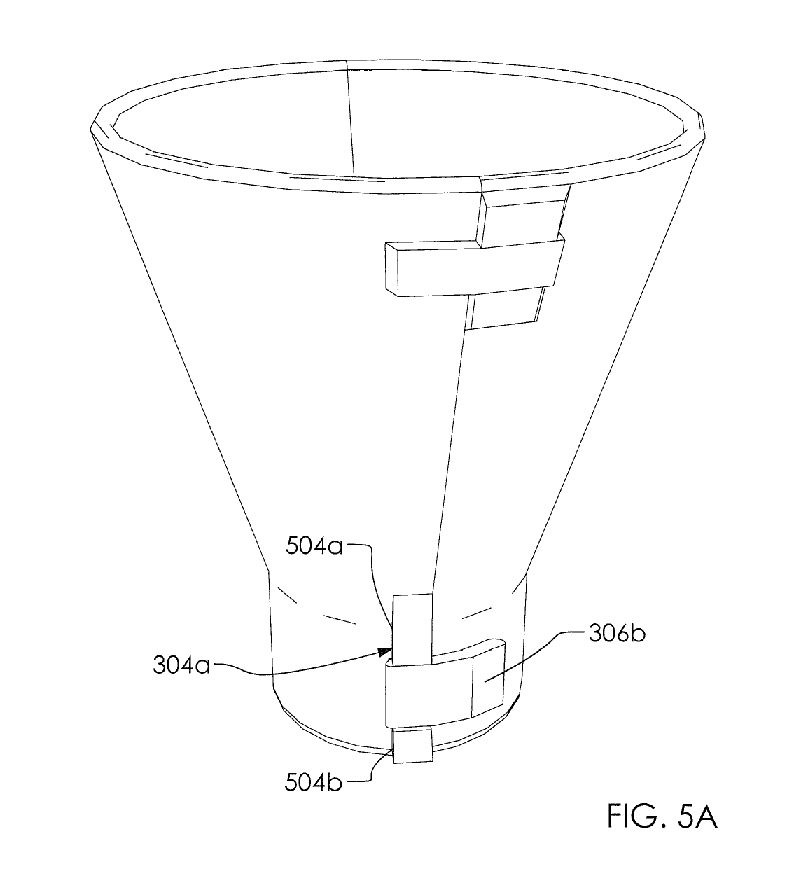

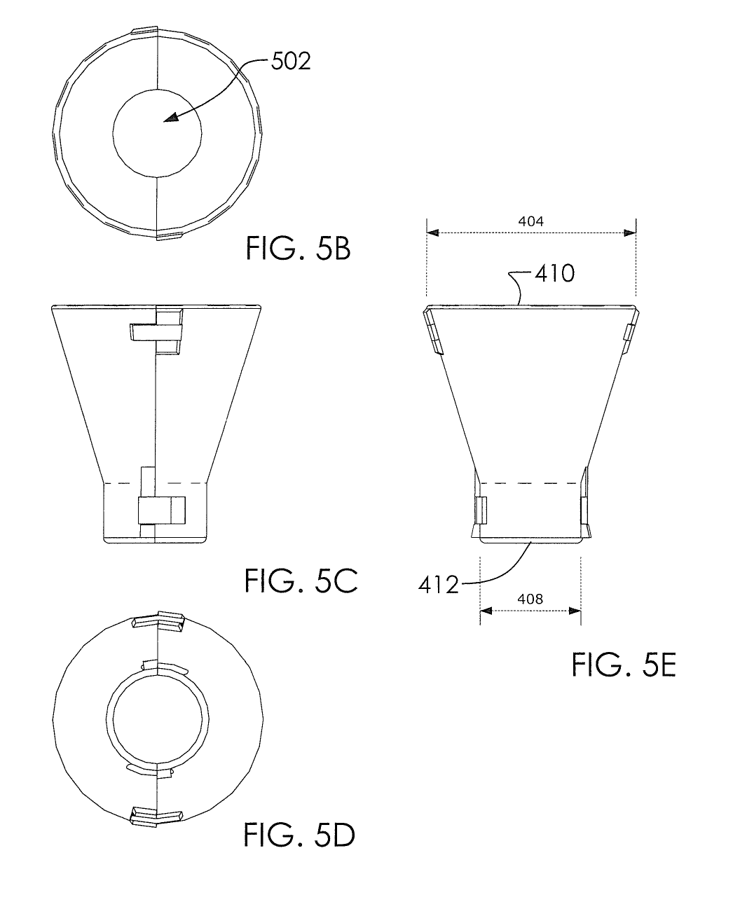

FIGS. 5A, 5B, 5C, 5D and 5E illustrate the pest protection system 200 in a perspective overview and four elevated views. FIG. 5B illustrates a top view of the pest protection system 200. FIG. 5C illustrates a front view of the pest protection system 200. FIG. 5D illustrates a bottom view of the pest protection system 200. FIG. 5E illustrates a side view of the pest protection system 200. As discussed above, the pest protection system 200 can comprise a substantially round diameter at the upper rim 410 and the lower rim 412; wherein, the upper rim 410 can comprise the upper external diameter 404 and the lower rim 412 can comprise a lower external diameter 408. In one embodiment, the pest protection system 200 can comprise an internal passage 502. In one embodiment, the internal passage 502 can allow the first end 210 of the fluid drainage hose 206 to pass through the pest protection system 200, as discussed and illustrated below. In one embodiment, the one or more receiving portions can comprise barriers above and below the one or more latching portions when the pest protection system 200 is in the assembled configuration. For example, in one embodiment, the first lower receiving portion 304a can comprise an upper barrier 504a and a lower barrier 504b which prevent the second lower latching portion 306b from sliding up and down relative to the first lower receiving portion 304a.

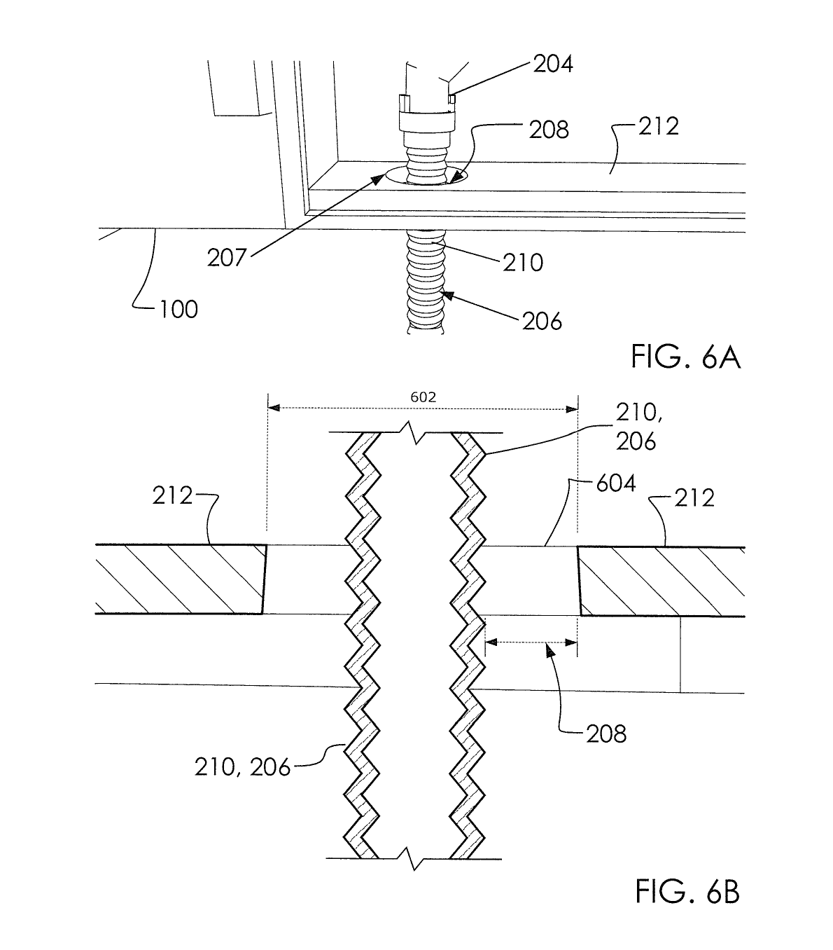

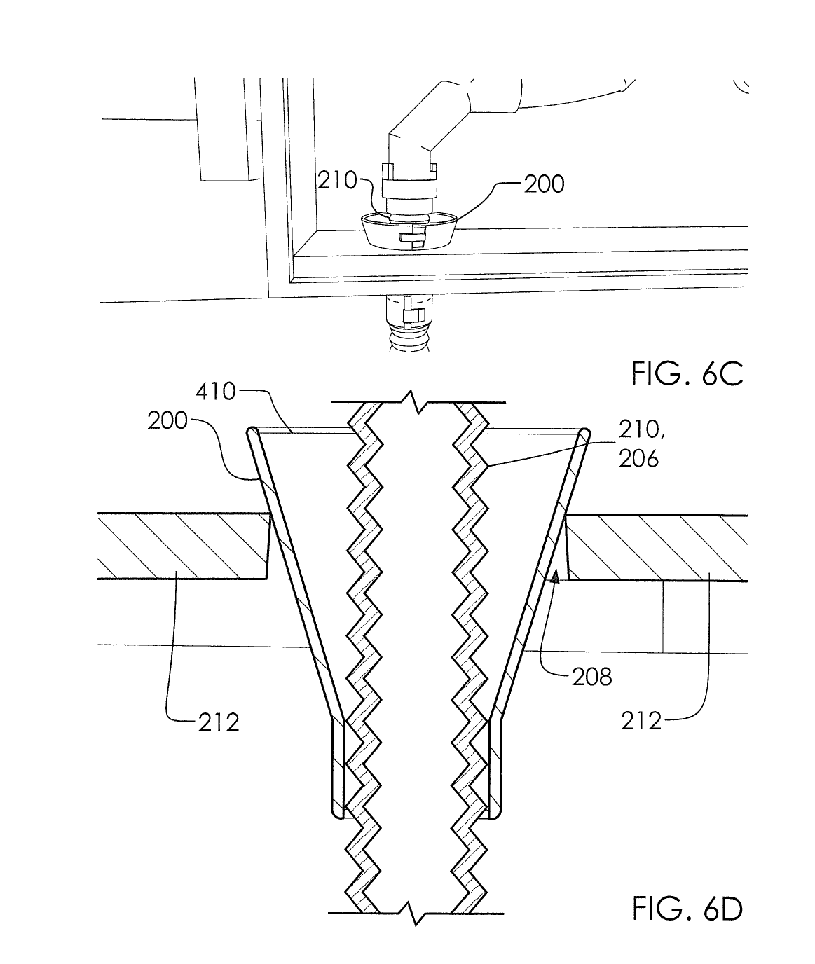

FIGS. 6A, 6B, 6C and 6D illustrate the pest protection system 200 in use in the mobile vehicle 100. FIGS. 6A and 6B illustrate the plumbing compartment 102 without the pest protection 200 installed in a perspective overview and an elevated cross-section front view. FIGS. 6C and 6D illustrate the pest protection system 200 installed into the plumbing compartment 102 in a perspective overview and an elevated cross-section front view. As illustrated, the pest protection system 200 can be used to seal off the gap 208. In one embodiment, the pest protection system 200 can fit around the first end 210 of the fluid drainage hose 206, as discussed above. In one embodiment, the gap 208, having an internal diameter 602, can be plugged by: assembling the pest protection system 200 around the first end 210 of the fluid drainage hose 206, sliding the pest protection system 200 down until the upper portions 332 of the pest protection system 200 presses around an upper portion 604 of the gap 208, as illustrated in FIGS. 6C and 60. In one embodiment, the upper external diameter 404 of the pest protection system 200 at the upper rim 410 can be larger than the internal diameter 602 of the gap 208.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A pest barrier device for plumbing of mobile vehicles comprising a pest protection system having a first half and a second half for positioning about a fluid drainage hose and sized to fit within a plumbing compartment of a mobile vehicle at a gap of a compartment floor of the plumbing compartment to substantially occupy the gap and to receive the drainage hose.

2. The device according to claim 1 comprising a lower portion and an upper portion, and wherein;
the lower portion comprises a lower rim to receives a portion of the fluid drainage hose having an external hose diameter; and
the upper portions and the lower portions come together at a joining point and comprise a latching system to allow the first half and the second half of the pest protection system to selectively attach to one another with the latching system between a detached configuration and an assembled configuration.

3. The device according to claim 2 wherein the latching system comprises a receiving portion to receive a latching portions.

4. A pest barrier system for plumbing of mobile vehicles, comprising:
a pest protection system having a first half, a second half, a lower portion and an upper portion;
the pest protection system further defining an internal passage;
the lower portion of the pest protection system comprises a lower rim; the upper portions of the pest protection system comprises an upper rim;
the lower rim comprises a lower external diameter and a lower internal diameter;
the upper rim comprises an upper external diameter;
the pest protection system fits within a plumbing compartment of a mobile vehicle at a gap of a compartment floor of the plumbing compartment;
the gap comprises an internal diameter;
the internal diameter of the gap is smaller than the upper external diameter of the upper rim of the pest protection system;
the lower portion of the pest protection system receives a portion of a fluid drainage hose having an external hose diameter; and
the lower internal diameter of the lower portion of the pest protection system is greater than or equal to the external hose diameter of the fluid drainage hose.

5. The pest barrier system of claim 4 wherein the upper portions of the pest protection system is conical.

6. The pest barrier system of claim 4 wherein the lower portions of the pest protection system is cylindrical.

7. The pest barrier system of claim 4 wherein:
the upper portion of the pest protection system is conical,
the lower portion of the pest protection system is cylindrical, and
the upper portion and the lower portion come together at a joining point.

8. The pest barrier system of claim 4 wherein:
the pest protection system further comprises a latching system;
the first half and the second half of the pest protection system are selectively attached to one another with the latching system between a detached configuration and an assembled configuration; and
the assembled configuration comprises the first half attached to the second half.

9. The pest barrier system of claim 8 wherein:
the latching system comprises a one or more receiving portions and a one or more latching portions; and
the one or more receiving portions releaseably attach to the one or more latching portions when the pest protection system is in the assembled configuration.

10. The pest barrier system for plumbing of mobile vehicles of claim 9 wherein:
the one or more receiving portions comprise a first lower receiving portion and a second lower receiving portion;
the one or more latching portions comprise a first lower latching portion and a second lower latching portion;
the first lower receiving portion is on the lower portions at a first vertical edge of the first half;
the second lower receiving portion is at the lower portions of a first vertical edge of the second half;
the first lower latching portion is on the upper portions of a second vertical edge of the second half;
the second lower latching portion is on the upper portions of a second vertical edge of the second half;
the second lower receiving portion receives the first lower latching portion; and the first lower receiving portion receives the second lower latching portion.

11. The pest barrier system for plumbing of mobile vehicles of claim 10 wherein:
the latching system comprises a one or more lip and tooth portions having a one or more teeth and a one or more lips; and
the one or more lips releaseably attach to the one or more teeth when the pest protection system is in the assembled configuration.

12. The pest barrier system for plumbing of mobile vehicles of claim 11 wherein: the one or more teeth comprise a lower tooth on the first half;
the one or more lips comprise a lower lip on the second half; and
the lower tooth releaseably attaches to the lower lip when the pest protection system is in the assembled configuration.

13. The pest barrier system for plumbing of mobile vehicles of claim 11 wherein:
the one or more latching portions comprise a tooth among the one or more lip and tooth portions;
the one or more receiving portions comprise a lip among the one or more lip and tooth portions; and

14. The pest barrier system for plumbing of mobile vehicles comprising of claim 10 wherein:
the one or more receiving portions comprise a first upper receiving portion and a second upper receiving portion;
the one or more latching portions comprise a first upper latching portion and a second upper latching portion;
the first upper receiving portion is on the upper portions at the first vertical edge of the second half;
the second upper receiving portion is at the upper portions of the first vertical edge of the first half;
the first upper latching portion is on the upper portions of the second vertical edge of the second half;
the second upper latching portion is on the upper portions of the second vertical edge of the first half;
the second upper receiving portion receives the first upper latching portion;
and the first upper receiving portion receives the second upper latching portion.

15. The pest barrier system for plumbing of mobile vehicles of claim 10 wherein the one or more receiving portions and the one or more latching portions are located on both the upper portions and the lower portions of the pest protection system.

16. The pest barrier system for plumbing of mobile vehicles of claim 10 wherein the one or more receiving portions comprise barriers above and below the one or more latching portions when the pest protection system is in the assembled configuration.

17. A method for precluding animal ingress into a fluid drainage portion of a motor vehicle, comprising positioning the device of claim 1 together and about a drainage hose of the vehicle.

18. A method for preventing damage to a plant, comprising:
providing a device having a first half and a second half for positioning about the plant; and
coupling the device together and about a portion of the plant.

19. The method according to claim 18 wherein the plant is a tree, and the device is positioned about a trunk of the tree.
